(19) United States
(12) Patent Application Publication
(10) Pub. No.: US 2023/0378506 A1
(43) Pub. Date: Nov. 23, 2023

(54) MEMBRANE-ELECTRODE UNIT FOR AN ELECTROCHEMICAL CELL, AND METHOD FOR MANUFACTURING A MEMBRANE-ELECTRODE UNIT

(71) Applicant: Robert Bosch GmbH, Stuttgart (DE)

(72) Inventors: Andreas Ringk, Bamberg (DE); Anton Ringel, Bamberg (DE)

(21) Appl. No.: 18/030,676

(22) PCT Filed: Oct. 5, 2021
(86) PCT No.: PCT/EP2021/077443

§ 371 Date: Apr. 6, 2023

(30) Foreign Application Priority Data
Oct. 19, 2020 (DE) 10 2020 213 132.5

(51) Int. Cl. H01M 8/1004; H01M 8/0273; H01M 8/0284; H01M 8/0286

(52) U.S. Cl. CPC H01M 8/1004; H01M 8/0273; H01M 8/0284; H01M 8/0286; H01M 2008/1095

(57) ABSTRACT

Disclosed is a membrane-electrode unit (1) for an electrochemical cell (100), wherein the membrane-electrode unit (1) comprises a frame structure (10) for accommodating a membrane (2) coated with electrodes (3, 4). The frame structure (10) comprises a first film (11) and a second film (12), between which an adhesive (13) is disposed. The first film (11) and the second film (12) are melted together in a bonding region (15).

### BACKGROUND

A fuel cell is an electrochemical cell, wherein these two electrodes are separated from one another by means of an ion-conducting electrolyte. The fuel cell converts the energy of a chemical reaction of a fuel directly into electricity using an oxidizing agent. Various types of fuel cells exist.

A specific fuel cell type is the polymer electrolyte membrane fuel cell (PEM-FC). In an active region of a PEM-FC, two porous electrodes having a catalyst layer abut on a polymer electrolyte membrane (PEM). In the active region, the PEM-FC further comprises gas diffusion layers (GDL) which border, on both sides, the polymer electrolyte membrane (PEM) and the two porous electrodes having a catalyst layer. The PEM, the two electrodes having the catalyst layer, and optionally also the two GDL can form a so-called membrane-electrode unit (MEA) in the active region of the PEM-FC. Two opposing bipolar plates (halves) in turn border the MEA on both sides. A fuel cell stack is constructed of MEAs and bipolar plates alternately arranged one above the other. With an anode plate of a bipolar plate, a distribution of the fuel, in particular hydrogen, takes place, and with a cathode plate of the bipolar plate, a distribution of the oxidizing agent, in particular air/oxygen, takes place. In order to electrically isolate adjacent bipolar plates, in order to stabilize the shape of the MEA, and in order to prevent unwanted escape of the fuel or of the oxidizing agent, the MEA can be enclosed in a frame-like opening of two films arranged on one another. Typically, the two films of this frame structure are made of the same material, e.g., polyethylene naphthalate (PEN). The two films formed from the same material may have dispensably redundant properties, such as an electrical insulating capability (electrically insulating) and/or an oxygen-tightness of each of the two films.

DE 101 40 684 A1 discloses a membrane-electrode unit for a fuel cell, containing a layer arrangement consisting of an anode electrode, a cathode electrode, and a membrane arranged between them, wherein a polymeric material is applied to an upper and a lower side of the layer arrangement.

DE 10 2018 131 092 A1 comprises a membrane-electrode unit with a frame structure.

The problem addressed by the present invention is to prevent adhesive from being pressed out of the frame structure and preferably to ensure a defined height of the frame structure.

### SUMMARY

For this purpose, the membrane-electrode unit comprises a frame structure for accommodating a membrane coated with electrodes. The frame structure comprises a first film and a second film, between which an adhesive is disposed. The first film and the second film are melted together in a bonding region. The two films are thus connected to one another in a materially locking fashion at the bonding region.

Preferably, the two films are made of the same material, particularly preferably a thermoplastic polymer such as PEN. The two films can thus be melted together in a very simple manner, for example by means of a hot punch.

The fusing of the two films creates a barrier against the adhesive agent, which can no longer be pressed out of the frame structure, in particular upon stacking and pressing of the electrochemical cells. The adhesive is virtually trapped in the frame structure. With the resulting defined volume of the comparatively incompressible adhesive, a defined homogeneous height of the membrane-electrode unit is set. Accordingly, a stack of cells can be clamped with more homogeneous contact pressure distributions, thereby tolerating the stack height in tighter bounds.

The membrane-electrode unit may comprise a membrane, in particular a polymer electrolyte membrane (PEM). The membrane-electrode unit may further comprise two porous electrodes each having a catalyst layer, wherein said electrodes are in particular arranged on the PEM and border it on both sides. This may in particular be referred to as an MEA-3. Additionally, the membrane-electrode unit may comprise two gas diffusion layers. These gas diffusion layers may in particular border the MEA-3 on both sides. This may in particular be referred to as an MEA-5.

For example, the electrochemical cell may be a fuel cell, an electrolysis cell or a battery cell. The fuel cell is in particular a PEM-FC (polymer electrolyte membrane fuel cell). In particular, a cell stack comprises a plurality of electrochemical cells arranged one above the other.

The frame structure in particular has a frame shape. The frame structure is preferably circumferential. A membrane and the two electrodes can thus be particularly advantageously enclosed in the frame structure. Furthermore, the frame structure in cross-section is in particular U-shaped or Y-shaped for accommodating the membrane and the two electrodes are formed between the legs of the U-shape or Y-shape.

When the two films are glued, they are preferably glued only at the lower leg of the Y-shape; between the two other legs, the membrane is arranged between the two films. The membrane can also be glued to both films.

The adhesive preferably seals the membrane-electrode unit toward the outside, glues the two films to one another and fixes the membrane with the two electrodes in the frame structure.

The adhesive can further preferably be electrically insulating. The frame structure can thus be particularly advantageously electrically insulating and an unwanted flow of current in an inactive region of the electrochemical cell is particularly advantageously kept low, in particular prevented.

In preferred further developments, the two films are melted together over a circumference of the active region. The adhesive thus seals the edge of the active region. This sealing function can be significantly better ensured when the adhesive agent is prevented from being pressed out.

In advantageous embodiments, the two films are melted together over a circumference of a distribution region. Thus, the adhesive seals the edge of the distribution region. This sealing function can also be significantly better ensured if the adhesive is prevented from being pressed out.

The invention also comprises a method for manufacturing a membrane-electrode unit according to any one of the above embodiments. The method comprises the following method step:
melting of the first film together with the second film in a bonding region by means of a hot punch.

Preferably, the hot punch is designed in two parts, so that each film can be brought into direct contact with a hot punch. Particularly preferably, this method is carried out by applying a retaining pressure during the melting operation, and especially during the cooling operation, so that both films can be bonded to one another in a secure manner.

### BRIEF DESCRIPTION OF THE DRAWINGS

Further measures improving the invention arise from the following description of a few embodiment examples of the invention, which are schematically illustrated in the figures. All of the features and/or advantages arising from the claims, description or drawings, including structural details, spatial arrangements and method steps, may be essential to the invention both by themselves and in the various combinations. It should be noted that the figures have only a descriptive character and are not intended to restrict the invention in any way.

The following are shown schematically:

FIG. 1 a membrane-electrode unit from the prior art, wherein only the essential regions are shown.

FIG. 2 a membrane-electrode unit according to the invention, wherein only the essential regions are shown.

FIG. 3 a schematic membrane-electrode unit in a perspective view, wherein only the essential regions are shown.

### DETAILED DESCRIPTION

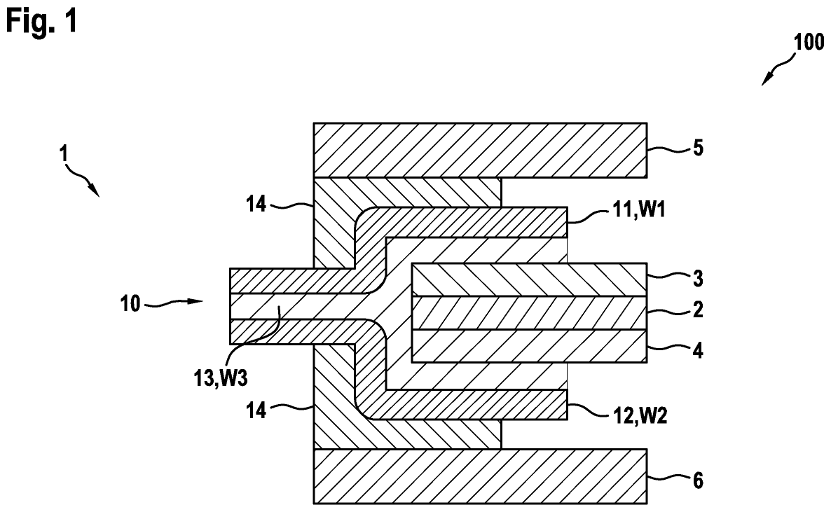

FIG. 1 shows a vertical section of a membrane-electrode unit 1 of an electrochemical cell 100, in particular of a fuel cell, from the prior art, wherein only the essential regions are shown.

The membrane-electrode unit 1 comprises a membrane 2, by way of example a polymer electrolyte membrane (PEM), and two porous electrodes 3 and 4 each having a catalyst layer, wherein the electrodes 3 and 4 are each arranged on one side of the membrane 2. The electrochemical cell 100 further comprises in particular two gas diffusion layers 5 and 6, which, depending on the embodiment, may also belong to the membrane-electrode unit 1.

The membrane-electrode unit 1 is circumferentially surrounded by a frame structure 10, this is also referred to as a sub-gasket. The frame structure 10 serves to provide stiffness and tightness to the membrane-electrode unit 1 and is a non-active region of the electrochemical cell 100.

The frame structure 10 is in particular U-shaped or Y-shaped in section, wherein a first leg of the U-shaped frame portion is formed by a first film 11 from a first material W1 and a second leg of the U-shaped frame portion is formed by a second film 12 from a second material W2. In addition, the first film 11 and the second film 12 are glued together by means of an adhesive 13 made of a third material W3. The first material W1 and the second material W2 are often identical.

The two gas diffusion layers 5 and 6 are in turn each arranged on one side of the frame structure 10 by means of a further adhesive 14, usually such that they are in contact with one electrode 3, 4 each in the active region of the electrochemical cell 100.

When clamping several electrochemical cells 100 into a cell stack, there is a risk that the adhesive 13 will be pressed out of the frame structure 10. This may result in leakage of the membrane-electrode unit 1 and, consequently, even total failure of the entire cell stack.

According to the present invention, the two films 11, 12 are now melted together or sealed at a bonding region 15 in such a way that adhesive 13 is prevented from leaking outwardly.

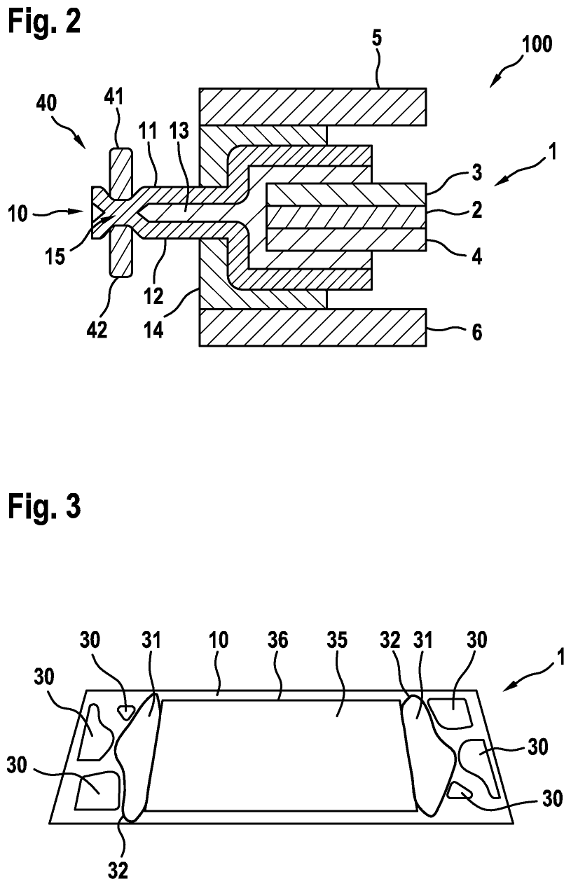

For this purpose, FIG. 2 shows a membrane-electrode unit 1 in cross-section, in which the first film 11 and the second film 12 are melted at the bonding region 15 so that the adhesive agent 13 is sealed. Leakage of the adhesive 13 in the illustration of FIG. 2, left, is then also no longer possible when the two films 11, 12 are pressed together.

The resulting locked-in volume of the adhesive 13 further ensures a defined height of the layer of the adhesive 13 and thus of the entire membrane electrode unit 1 in the stacking direction of the electrochemical cells 100, because a defined distance between the two films 11, 12 is maintained.

In FIG. 2, an associated manufacturing method for the membrane electrode unit 1 is further outlined. The fusing or materially locking connection of the two films 11, 12 is preferably produced by means of a hot punch 40. In the described embodiment, the hot punch 40 comprises a first punch 41 and a second punch 42. The two punches 41, 42 are heated during the manufacturing step and fed towards one another at the bonding region 15 so that the first punch 41 acts on the first film 11 and the second punch 42 acts on the second film 12. The two punches 41, 42 are moved towards one another until the first film 11 comes into contact with the second film 12 in the bonding region 15. The high temperatures of the two punches 41, 42 melt the two films 11, 12 at least at the bonding region 15 so that the associated polymer chains can be connected; after cooling of the two films 11, 12, a materially locking connection between the two films 11, 12 is thus formed in the bonding region 15.

This manufacturing step for fusing the two films 11, 12 can preferably be combined with further manufacturing steps, for example punching processes on the membrane electrode unit 1 or a cutting of the frame structure 10.

FIG. 3 shows a perspective view of the membrane electrode unit 1 in a schematic representation. In the middle of the membrane-electrode unit 1, the preferably rectangular active region 35 with the coated membrane is located. The coated membrane is circumferentially framed by the frame structure 10. In the embodiment of FIG. 3, the frame structure 10 has three distribution openings 30 at each of its narrow front sides for supplying and discharging the media of fuel, oxidizers, and coolants. Between the distribution openings 30 and the active region 35, the so-called distribution region 31 is configured, which serves to distribute (on the supply side) or collect (on the discharge side) the media from the comparatively narrow distribution openings 30 to the comparatively wide active region 35.

In preferred embodiments of the invention, the two films 11, 12 of the frame structure 10 are now melted together at a circumference 36 of the active region 35 and/or at a circumference 32 of the distribution region 31, thereby defining the volume amounts of adhesive 13 in the corresponding regions 31, 35, and the adhesive 13 can no longer penetrate. A homogeneous thickness of the membrane-electrode unit 1 is thus robustly set, and the respective regions 31, 35 are very well sealed.

1. A membrane-electrode unit (1) for an electrochemical cell (100), wherein the membrane-electrode unit (1) comprises a frame structure (10) for accommodating a membrane (2) coated with electrodes (3, 4), wherein the frame structure (10) comprises a first film (11) and a second film (12), between which an adhesive (13) is disposed,
wherein
the first film (11) and the second film (12) are melted together in a bonding region (15).

2. The membrane-electrode unit (1) according to claim 1,
wherein
the two films (11, 12) are made of the same material.

3. The membrane-electrode unit (1) according to claim 1,
wherein
the two films (11, 12) are made of a thermoplastic polymer.

4. The membrane-electrode unit (1) according to claim 1,
wherein
the two films (11, 12) are melted together over a circumference (36) of an active region (35).

5. The membrane-electrode unit (1) according to claim 1,
wherein
the two films (11, 12) are melted together over a circumference (32) of a distribution region (32).

6. A method for producing a membrane-electrode unit (1) according to claim 1, wherein the membrane-electrode unit (1) comprises a frame structure (10) for accommodating a membrane (2) coated with electrodes (3, 4), wherein the frame structure (10) comprises a first film (11) and a second film (12), between which an adhesive (13) is disposed,
the method comprising:
melting of the first film (11) together with the second film (12) in a bonding region (15) by a hot punch (40).

7. The membrane-electrode unit (1) according to claim 3, wherein the two films (11, 12) are made of PEN.
